(19) United States
(12) Patent Application Publication
(10) Pub. No.: US 2007/0184249 A1
(43) Pub. Date: Aug. 9, 2007

(54) Composite panel and method

(76) Inventors: Raymond P. Barnes, Brighton, MI (US); Richard A. Hager, Commerce Township, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/615,053

(22) Filed: Dec. 22, 2006

Related U.S. Application Data
(60) Provisional application No. 60/754,130, filed on Dec. 27, 2005.

(51) Int. Cl. B32B 1/00

(52) U.S. Cl. 428/174; 428/138

(57) ABSTRACT

An instrument panel is provided having a skin, a substrate material, and a filler material. A portion of the skin contacts the substrate material and the remaining portion of the skin and substrate material create a gap in which the filler material is inserted. The substrate material defines at least one vacuum hole that extends to the substrate material towards the skin so that vacuum pressure can maintain the connection between the skin and the substrate material while the filler material is being placed into the gap. Also, a portion of the skin and the substrate material create a locking mechanism where the filler material applies a force to the skin and substrate material.

### RELATED APPLICATIONS

This application claims the benefit of earlier filed U.S. Provisional Application Ser. No. 60/754,130, filed Dec. 27, 2005, which is incorporated herein by reference in its entirety.

### TECHNICAL FIELD

The present invention relates to the formation of a composite panel and to an instrument panel for a vehicle.

### BACKGROUND

Many vehicles have instrument panels on the interior of the vehicle which are used for, among other things, various displays. Conventional manufacturing of such instrument panels can be timely and costly due to complexities in forming the instrument panel while maintaining an acceptable surface finish.

Furthermore, the instrument panel is difficult to manufacture because in some prior designs the instrument panel uses flanges to connect the various parts. Additionally, many of the parts forming the assembly have to be trimmed after forming. This trimming step is an additional manufacturing step that requires additional time and cost. Also, in other designs, sealing tapes are required to prevent a filler material from protruding onto the exterior surface of the instrument panel to thereby help maintain the acceptable exterior finish of the instrument panel.

In yet another design separate trim parts can be used to cover the trimmed edges and thereby create an aesthetically pleasing part. Edges from the forming process must be trimmed and the trim parts are placed over the trimmed edges in an additional manufacturing step. Each of the foregoing methods to manufacture an instrument panel require additional steps of altering the instrument panel structure after the forming process. It is therefore desirable to develop an instrument panel that can be manufactured without the need for add-on trim parts or secondary trimming operations.

### SUMMARY

The present invention relates to an instrument panel which has a skin, a substrate material, and a filler material. A portion of the skin contacts the substrate material and the remaining portion of the skin and substrate material create a gap in which the filler material is injected into. Furthermore, the substrate material contains at least one vacuum hole that extends to the substrate material towards the skin so that vacuum pressure can maintain the connection between the skin and the substrate material while the filler material is being injected into the gap.

The skin includes an extension and a flange that is inserted into a detent area of the substrate material. The flange and extension act as a locking mechanism once the filler material is injected into the gap. Thus, after the filler material is injected into the gap, the filler material forces the flange and the extension into the detent area toward the substrate material so that the instrument panel will maintain its shape.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of the instrument panel.

### DETAILED DESCRIPTION

The following description of the preferred embodiment(s) is merely exemplary in nature and is in no way intended to limit the invention, its application, or uses.

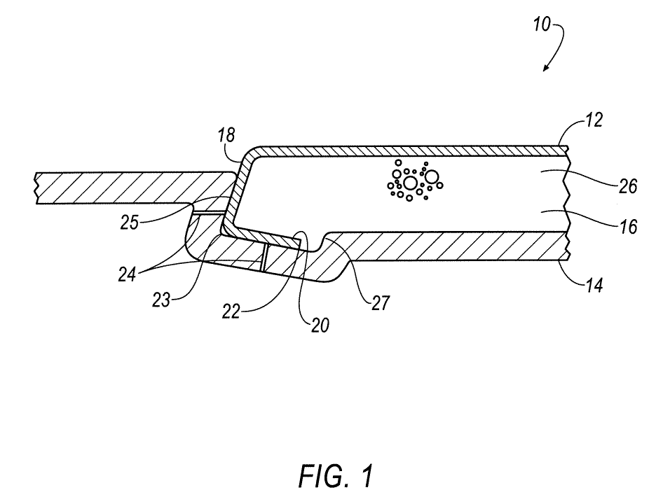

Referring to FIG. 1, an instrument panel is generally shown at 10. The instrument panel 10 comprises a first material, which is preferably a skin 12, and a second material, which is preferably a substrate material 14. Skin 12 is placed adjacent to the substrate material 14 so that a portion of the skin 12 contacts a portion of the substrate material 14, and a gap 16 is created between the remaining portion of a skin 12 and the substrate material 14. In a preferred embodiment, skin 12 is a urethane material such as a vinyl that is qualified as a class “A” finish material. In an embodiment, the substrate material 14 is an ABS or a polypropylene material. However, the substrate material 14 can be any material sufficient to impart the strength requirements for various forces that are typically associated with an instrument panel 10.

In an embodiment, skin 12 has an extension 18 that extends from the skin 12 into the gap 16 towards the substrate material 14. Extension 18 has a flange 20 which extends along or parallel to the surface of the substrate material 14. Substrate material 14 has a detent area 22 where the height of a base portion 23 of the detent area 22 is lower than at other portions of the substrate material 14. Detent area 22 is formed by a U-shaped portion in cross section of the instrument panel 10 which includes the base portion 23, an outer peripheral wall 25, and an upward extending wall 27. Thus, the outer peripheral wall 25 and the upward extending wall 27 form the walls of the detent area 22. Outer peripheral wall 25 is slanted inwardly such that extension 18 and flange 20 are inserted into the detent area 22, and the extension 18 extends along or parallel to at least one of the wall surface of detent area 22. In an embodiment, flange 20 extends from extension 18 along or parallel to the base portion 23.

The substrate material 14 defines a vacuum hole 24 which extends through the substrate material 14. The substrate material 14 can contain any number of vacuum holes 24, but in a preferred embodiment, the vacuum holes 24 are placed in the detent area 22 where the skin 12 contacts the substrate material 14. Preferably, a series of vacuum holes 24 are provided on the outer peripheral wall 25 and base portion 23. In an embodiment, the vacuum hole 24 is a small hole so that the vacuum hole 24 does not interfere with the strength characteristics of the substrate material 14. For example, if the vacuum holes 24 are too large then the overall force that the substrate material 14 can withstand will be reduced since large areas of the instrument panel 10 will not contain the substrate material 14.

In an embodiment, skin 12 and the substrate material 14 are pre-manufactured and placed into a tool (not shown), such that the tool has a cavity (not shown) in which the skin 12 contacts one surface and the substrate material 14 contacts another surface. The tool creates vacuum pressure on the side of the substrate material 14 that is opposite skin 12 so that a vacuum pressure is created in the vacuum hole 24. The vacuum pressure maintains the connection between skin 12 and substrate material 14 while skin 12 and substrate material 14 are in the tool.

Next, a filler material 26 is injected into the gap 16 while the skin 12 and the substrate material 14 remain in the tool with the vacuum pressure applied. In an embodiment, the filler material 26 is an urethane foam which will expand once it is injected into the gap 16. As the filler material 26 is injected into the gap 16, the filler material 26 applies a force on skin 12 and substrate material 14 which will put a strain on the connection point. However, the connection between the skin 12 and the substrate material 14 will be maintained throughout the injection process by the vacuum pressure in the vacuum holes 24 which applies a force on the skin 12 that pulls the skin 12 towards the substrate material 14. In an embodiment, the tool will be shaped so that any excess filler material 26 will be forced out of the gap 16 so that the skin 12 and the substrate material 14 are not misshaped during the forming process.

Once instrument panel 10 is removed from the tool, the vacuum holes 24 no longer create a force on the skin 12 since the tool is no longer creating a vacuum pressure on one side of the substrate material 14. However, the filler material 26 applies a force on the skin 12 towards the substrate material 14. Thus, the filler material 26 is pushing against the extension 18 and the flange 20 which contacts the substrate material 14. This combination of the filler material 26 applying a force against the extension 18 and the flange 20 into the substrate material 14 acts as a locking mechanism to maintain the connection between the skin 12 and the substrate material 14 and the shape of the instrument panel 10 once it is removed from the tool. Furthermore, the outer peripheral wall 25 is slanted inwardly to facilitate this mechanical locking connection. In an alternate embodiment, a portion of the filler material 26 is inserted into the vacuum hole 24 during the injection process. Thus, if the vacuum hole 24 is large, the filler material 26 can enhance the strength characteristics of the substrate material 14 since the substrate material 14 will no longer have a large hole.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for forming an instrument panel comprising the steps of:
placing a first material and a second material into a tool, wherein a portion of said first material contacts said second material and a gap is created between the remaining portion of said first material and said second material; and
forming said instrument panel while retaining the connection between said first material and said second material by vacuum pressure, wherein at least one vacuum hole extends through said second material.

2. The method for forming an instrument panel of claim 1, wherein said first material is a skin and said second material is a substrate material.

3. The method for forming an instrument panel of claim 1 further comprising the step of inserting a filler material into said gap while said vacuum pressure maintains the contact between said first material and said second material.

4. The method for forming an instrument panel of claim 3, wherein said filler material is a foam material.

5. The method of forming an instrument panel of claim 1 further comprising the step of placing a flange of said first material into a detent area of said second material, such that said vacuum hole extends through said second material to said first material.

6. The method of forming an instrument panel of claim 1 further comprising a locking mechanism that maintains the connection between said first material and said second material after the forming processes, wherein said locking mechanism comprises a portion of said first material and an outer peripheral wall, a base portion, and an upward extending wall of said second material such that said portion of said first material is forced into at least one of said outer peripheral wall, said base portion, and said upward extending wall.

7. An instrument panel comprising:
a skin;
a substrate material, wherein a portion of said skin contacts said substrate material and the remaining portion of said skin creates a gap between said skin and said substrate material;
a filler material that is placed in said gap; and,
at least one vacuum hole that extends through said substrate material, wherein said at least one vacuum hole extends through a portion of said substrate material that contacts said skin.

8. The instrument panel of claim 7 further comprising a locking mechanism that maintains the connection between said first material and said second material after the forming processes, wherein said locking mechanism comprises a portion of said first material and an outer peripheral wall, a base portion, and an upward extending wall of said second material such that said portion of said first material is forced into at least one of said outer peripheral wall, said base portion, and said upward extending wall.

9. The instrument panel of claim 7 further comprising a flange on said skin, wherein said flange is said portion of said skin that contacts said substrate material.

10. The instrument panel of claim 7 further comprising a detent area in said substrate material, wherein said skin contacts said substrate in said detent area.

11. The instrument panel of claim 10, wherein said vacuum hole extends through said substrate material in said detent area.

12. The instrument panel of claim 7, wherein said filler material is a foam material.

13. The instrument panel of claim 7, wherein said skin is a material qualified as a class “A” finish.

14. The instrument panel of claim 7, wherein said substrate material is at least one of an ABS material and a polyurethane material.

15. An instrument panel comprising:
a skin;
a substrate material, wherein a portion of said skin contacts said substrate material and the remaining portion of said skin creates a gap between said skin and said substrate material;
a filler material that is placed in said gap; and,
a locking mechanism, wherein said locking mechanism is an extension and a flange that extend from said skin placed in a detent area of said substrate material and said filler material forces said extension and said flange towards said detent area.

16. The instrument panel of claim 15, wherein at least one vacuum hole extends through said substrate material, wherein said at least one vacuum hole extends through said substrate material to said skin.

17. The instrument panel of claim 16, wherein said vacuum hole extends through said substrate material in said detent area to said flange.

18. The instrument panel of claim 15, wherein said filler material is a foam material.

19. The instrument panel of claim 15, wherein said skin is a material qualified as a class “A” finish and said substrate material is at least one of an ABS material and a polyurethane material.

20. The instrument panel of claim 15, wherein said detent area of said locking mechanism is formed by an outer peripheral wall, a base portion, and an upward extending wall of said substrate, such that said extension extends along said outer peripheral wall and said flanges extends along said base portion.
